(19) United States
(12) Patent Application Publication
(10) Pub. No.: US 2022/0056261 A1
(43) Pub. Date: Feb. 24, 2022

(54) FIRE RETARDANT EPOXY RESIN

(71) Applicant: SAFRAN CABIN INC., Hunting Beach, CA (US)

(72) Inventors: Bhaskar Biswas, Marysville, WA (US); Jack V. Lally, Marysville, WA (US)

(21) Appl. No.: 16/341,040

(22) PCT Filed: Mar. 28, 2019
(86) PCT No.: PCT/US19/24588

§ 371 Date: Apr. 10, 2019

(51) Int. Cl. C08L 63/04; C08G 59/50; C08G 59/42; C08G 59/62; C08G 59/40; C08G 59/22; C08G 59/24; C08G 59/38; C08G 59/14; C08K 3/016; C08K 5/00

(52) U.S. Cl. CPC C08L 63/04; C08G 59/50; C08G 59/42; C08G 59/621; C08G 59/4064; C08G 59/223; C08L 2205/025; C08G 59/38; C08G 59/1488; C08K 3/016; C08K 5/0066; C08L 2201/02; C08G 59/245

(57) ABSTRACT

A composition formed of an epoxy resin incorporating a fire retardant.

### CROSS REFERENCE TO RELATED APPLICATIONS

This application is a national stage application, filed under 35 U.S.C. § 371, of International Patent Application No. PCT/US19/24588 filed Mar. 28, 2019, the entirety of which is incorporated herein by reference.

### FIELD OF THE INVENTION

The present invention relates to resin application, prepreg production, resin transfer processes, resin infusion processes, and composite parts for various industries.

### BACKGROUND OF THE INVENTION

Epoxy resins are widely known and versatile for many applications. An epoxy resin is a product from a reaction between epichlorohydrin and diglycidyl ether of bisphenol A, bisphenol F or bisphenol S. The functional chemical group formed from the reaction is known as all epoxide group as shown in FIG. 1. An epoxide group is a ring structure of an oxygen atom with two carbon atoms. The epoxy resins are classified based upon the number of epoxide functionalities in the chemical structure of the epoxy resins, for example di, tri and tetra functionalities. More common epoxy resins are DiGlycidyl Ether of Bisphenol A (DGEBA) (see FIG. 2), DiGlycidyl Ether of Bisphenol F (DGEBF) (see FIG. 3), Diglycidyl ether of bisphenol S (see FIG. 4), TriGlycidyl ParaAmino Phenol (TGPAP) (see FIG. 5), and Tetra Glycidyl Diamino Diphenyl Methane (TGDDM) (see FIG. 6).

There are also other types of epoxy resins where the glycidylation of the raw chemical is carried differently. Reaction of phenols with formaldehyde and subsequent glycidylation with epichlorohydrin produces epoxidised novolac (see, e.g., FIG. 7), such as epoxy phenol novolacs (EPN) and epoxy cresol novolacs (ECN). These are highly viscous to solid resins with typical mean epoxide functionality of around 2 to 6.

There are also other types of epoxy resins which are cycloaliphatic epoxy resins and are used as diluents to reduce the viscosity of the resin. In some cases, the cycloaliphatic epoxy resins (see FIG. 8) are also used as a toughening agent to reduce brittleness properties of the epoxy resin.

The above epoxy resins are the base resin. In order to obtain thermosetting characteristics of the epoxy resins, i.e., irreversible infusible form of epoxy resin, these base resins are required to react with a hardener (also known as curing agent or curatives) where the reaction between the base resin and the hardener takes place at different temperature for a certain period of time. The temperature and time vary for one type of base epoxy resin to another, and for one type of hardener/curing agent to another. The available curing agents are nitrogen based, e.g., amines, amides or imidazole containing curing agent, oxygen based, e.g., carboxylic acid, anhydride containing curing agents, benzoic structure or phenol or thiol containing hardeners.

### SUMMARY OF THE PREFERRED EMBODIMENTS

An epoxy resin is modified by the addition of fire retardants (“FR”) in its backbone to impart resistance to the fire and provide a reduction of flammability of the epoxy resin. The formulated epoxy resin is used in composite applications where the resin is used as a constituent. The incorporation of flame retardants in the chemical structure of the epoxy resin enables it to meet the regulatory requirement of flammability properties for the use in aircraft structures (e.g., interior structures) and other industries.

The principle of the invention is to include additives in the chemical structures of epoxy resin, its curing agent and diluents, or any carrier to be added to any of the aforementioned chemicals, which can impart or improve the required properties to these chemicals, so that the formulated epoxy resin is able to reduce flammability and resist fire. In a preferred embodiment, a fast curing fire retardant epoxy resin to be used in composite production for aerospace interior applications and for other industries, such as automotive, transport, industrial and others, is produced.

The fire retardation process of epoxy resin helps to modify the backbone of the chemical structure of the epoxy resin, so that fire retardant can be chemically integrated with the epoxy resin. The fire retardation process helps the epoxy resin to act in both condensed phase as well as in gas phase, in order to delay ignition time, produce shield protection against the fire and improve overall fire proof properties. It is possible to add two or more fire retardants to the fire retardant modified epoxy resin formula in order to obtain a synergistic effect of fire retarding in the epoxy resin, where the fire retardants are compatible to the epoxy resin.

The addition of at least one flame retardant and at least one intumescent to the epoxy resin is most effective to obtain fire retardancy of the epoxy resin, where the fire retardant and the intumescent give synergistic effect to impart fire retardancy to the epoxy resin. With the combination of an initiator and an accelerator in the epoxy resin system, it is possible to reduce the cure time of the curing agent. The formulated epoxy resin can cure faster, where the cure dwell time of the cure can be as low as possible, i.e., 15 minutes or less. The addition of fire retarded accelerator or initiator helps to bring further fire retardancy to epoxy resin system. The formulated epoxy resin can meet the regulatory requirements for the application in aircraft interior structures. It is possible to impart fire retarding properties to the epoxy resin without any adverse effect to any other properties of the epoxy resin. It is also possible to impart toughness by improving flexibility of epoxy resin system where the fire retarding properties can be maintained to attain regulatory requirement. The addition of coupling agent improves the compatibility between the epoxy resin components and other additives.

It is possible to modify the additive properties by adding chemicals where the additive can be a carrier of the chemical to the epoxy resin formulation. In this embodiment, the coupling agent can also act as a carrier of an additive. Addition of conductive chemicals helps to dissipate the absorbed heat in the resin system, therefore it delays the ignition of the resin. Thus, it allows longer time for evacuation, which is one of the regulatory requirements. It is also possible to reduce the viscosity of the epoxy by adding diluents so that the epoxy resin does not require additional heating arrangement during application. The percentage of diluents can vary from one application of the resin to another. All the chemicals used in the invention are preferably in liquid form which helps to maintain the viscosity of the formulation, as a result it is easier to handle for the impregnation process or resin infusion process or resin transfer process.

The formulated epoxy resin can be used for resin transfer molding, resin infusion molding, pultrusion, hand or spray layup process, prepreg manufacturing process, or any application where the final product is a composite or for the application in the composite production.

### BRIEF DESCRIPTION OF THE DRAWINGS

The invention may be more readily understood by referring to the accompanying drawings in which:

FIG. 1 shows an epoxide group;

FIG. 2 shows DiGlycidyl Ether of Bisphenol A (DGEBA);

FIG. 3 shows DiGlycidyl Ether of Bisphenol F (DGEBF);

FIG. 4. shows Bisphenol S epoxy resin—(diglycidyl ether of bisphenol S);

FIG. 5. shows TriGlycidyl Para Amino Phenol (TGPAP) or Tri-functional epoxy resin;

FIG. 6 shows TetraGlycidyl Diamino Diphenyl Methane (TGDDM) or Tetra-functional epoxy resin;

FIG. 7 shows Epoxy Novolac Resin; and

FIG. 8 shows Cycloaliphatic Epoxy Resin.

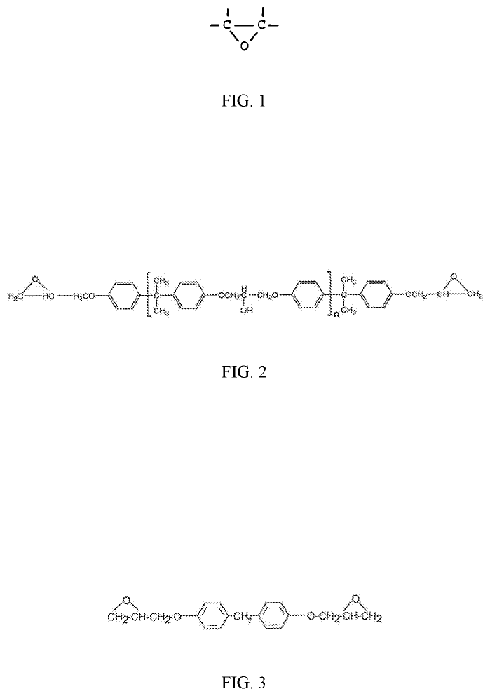

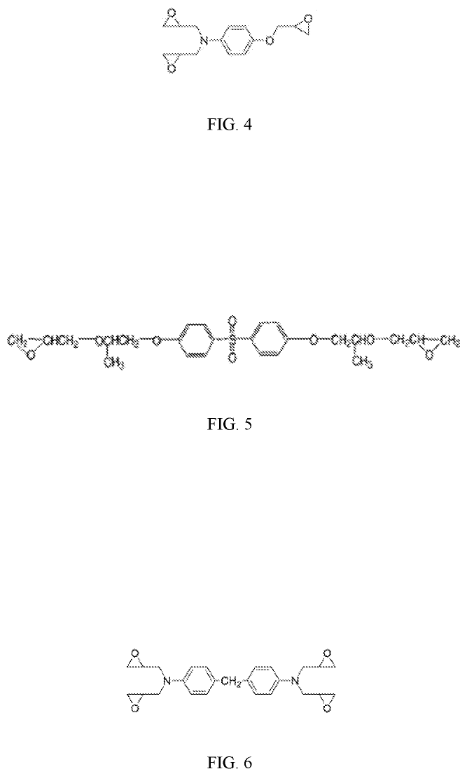

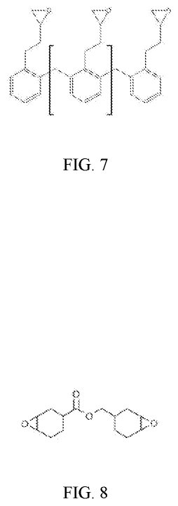

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

An epoxy resin is not inherently flame retardant. In general it is unable to meet the requirements of flammability, in particular for the application of resin in aircraft structures (e.g., interior structures). One preferred purpose of the present invention is to impart fire retarding properties to an epoxy resin so that it can be used where fire retardation is required, low flammability is required and this will allow to use the fire retardant epoxy resin for the application in aircraft interior structures, where it has to meet the flammability properties as per regulatory requirement. In addition, preferably, the invention provides epoxy resins that will be able to replace the phenolic resin system, as the epoxy resins are mechanically stronger than phenolic resin. It will help to improve mechanical properties of the structures (e.g. composites).

Since the epoxy resin is stronger than phenolic resins, this will help to alleviate the process requirements. For example, epoxy based prepregs can be used in oven cure to replace application autoclave cured phenolic based prepregs.

Since, the epoxy resin evolves lower moisture and is volatile during the curing reaction, it cause low number of pores and void formation. Thus, it improves the surface finish of the part made from it. Therefore, less preparation is required in case of painting process. Epoxy resin is not as hazardous as phenolic resin. This will give better acceptance of the resin for production.

The inclusion of flame retardant in the present invention helps to impart fire retarding properties to the epoxy resin; and hence, it is capable of meeting the regulatory requirement (e.g., FAA standard, FAR 25.853 for aircraft interior applications, CAA standard by EASA, etc.).

In general, epoxy resin does not have inherent fire retarding characteristics as does phenolic resin. Therefore, epoxy resin has a drawback which is high flammability or poor fire resistance. In order to make epoxy resin fire retardant, there are additives, e.g., fire retardants that can be added to the epoxy resin in order to make it fire retardant. There are different types of flame retardants available. These are phosphorus containing, nitrogen containing, silicon containing, halogen containing, mineral containing, and boron containing. The mineral containing fire retardants, e.g., aluminum trihydrate (ATH), and magnesium hydroxide (MgOH) are more commonly used across the industries. However, the phosphorus based fire retardants have advantages over mineral containing fire retardants. The mineral containing fire retardants are additive in nature which require higher percentage of loading in the formula, whereas the reactive fire retardants requires much less percentage of loading than that required for mineral containing fire retardants. These FRs could be phosphorus containing fire retardants, for example ammonium polyphosphate, melamine phosphate, organophosphorus, red phosphorus, and intumescent. Furthermore, there are other types of FRs, such as nitrogen containing FRs (e.g., melamines, cyanides etc), silicon containing FRs (e.g., polyhydro oligomeric silsesquioxane), boron containing FRs (e.g., zinc borate), halogen containing FRs (e.g. Decabromo diphenyl ether and tetrabromophenol). However, the halogenated FRs have limited application due to its high toxicity. Other FRs include: (I) Phosphorus containing FRs—phosphonic acid, phosphate ester, phosphonate, phosphinate, Triphenyl phosphate, Tritolyl phosphate, tricresyl phosphate, triaryl phosphate, resorcinol bis(diphenyl phosphate), bisphenol A bis(diphenyl phosphate), polyphosphonate, phosphinic acid salts, red phosphorus; (II) nitrogen containing FRs—melamines, melamine cyanurate; (III) phosphorus and nitrogen containing FRs—Ammonium phosphate, diammonium phosphate, triammonium phospate, ammonium poly phosphate, melamine phosphate, melamine polyphaste, melamine pyrophosphate, Guanidine phosphate, 9, 10-dihydro-9-oxa-10-phosphaphenanthrene-10-oxide (DOPO); (IV) Silicon based FRs—polyhedral oligomeric silsequioxane (POSS); (V) Boron based FRs—Zinc Borate, Sodium borate, ammonium borate, barium metaborate; (VI) Mineral based FRs—Aluminum trihydrate, Magnesium hydroxide, mica, zeolite, bentonite, iron oxide; (VII) Intumescents; (VIII) Pentaerythritol based FRs and (IX) expandable graphites.

In one preferred embodiment of this invention, a chemical mixing process takes place between a multi-functional epoxy resin (i.e. trifunctional, tetra functional, epoxy phenol novolacs or epoxy cresol novolacs) with a standard difunctional epoxy resin (Bisphenol A or Bisphenol F or Bisphenol S containing epoxy resin) and a flame retardant at a temperature range between 50° C. to 200° C., preferably between 90° C. to 160° C. in a controlled environment. The controlled environment is by maintaining the temperature at 130° C. or 125-135° C., and by maintaining inert atmosphere which is done by purging with inert gases. In a preferred case it is nitrogen. There are other inert gases, for example—helium, argon, and other inert gases.

The percentage of the multifunctional epoxy resin mixed in the formula is between 10 to 90% (w/w), and percentage of standard difunctional epoxy resin mixed in the formula is between 10 to 90% (w/w), and loading of fire retardant mixed in the formula is between 0 to 40% (w/w). The mixed chemicals are cooled down to temperature between 20° C. to 90° C., preferably between 40° C. to 80° C., where a diluent epoxy resin can be added at lower temperature once the cool down process takes place. Diluents are used to dilute the chemical (particularly high viscous, thixotropic paste of chemicals). Diluents improve the flowability of the high viscous and/or thixotropic chemicals. The diluent epoxy resin has very low viscosity. Mixing the low viscous diluent epoxy resin to high viscous resin (R) reduces the viscosity of the resin (R). Thus it improves the handle-ability and process-ability. Specific diluents include predominantly monofunctional epoxy resins and aliphatic epoxy resins, e.g., C8-C10 aliphatic glycidyl ether (CVC speciality chemicals-Erisys GE 7), C12-C14 glycidyl ether (Olin—DER 721, Evonik—Epodil 741, CVC speciality chemicals—Erisys GE 6), ethyl hexyl glycidyl ether (CVC speciality chemicals—Erisys GE 6), ortho-cresyl glycidyl ether (Olin—DER 723, Evonik—Epodil 742), 1,4-butanediol diglycidyl ether (Olin—DER 731, CVC speciality chemicals—Erisys GE 21), trimethylon propane triglycidyl ether (Evonik—Epodil 762, Aditya Birla—RD113), and Neopentyl glycol diglycidyl ether (CVC speciality chemicals—Erisys GE 20).

The proportion of the diluent epoxy resin varies from 0 to 90% (w/w), preferably 10 to 80% (w/w), more preferably 20 to 60% (w/w). After mixing for 24 hours, preferably less 12 hours, more preferably less than 6 hours, the chemical resin mixture is cooled down to room temperature. This chemical formula is called as Formula B which is base resin of this invention (and is show below to the right)

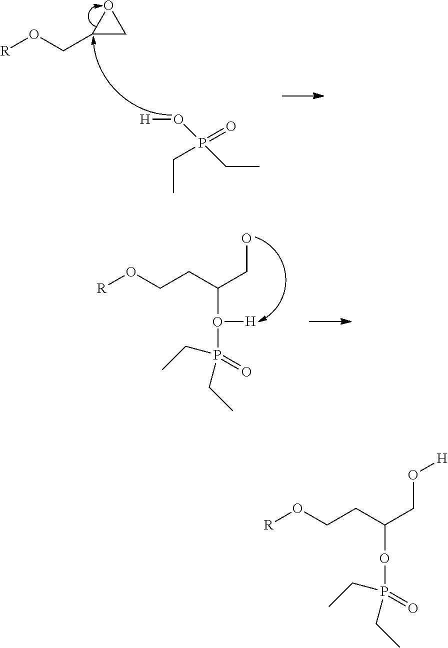

where R is the epoxy resin with at least one epoxide group, and the HPO2 group is the flame retardant with phosphinic acid group. In this regard, R can be chosen from any epoxy resin including one or more of the following: DiGlycidyl Ether of Bisphenol A (DGEBA), DiGlycidyl Ether of Bisphenol F (DGEBF), Bisphenol S epoxy resin—(i.e. diglycidyl ether of bisphenol S), TriGlycidyl Para Amino Phenol (TGPAP) or Tri-functional epoxy resin, TetraGlycidyl Diamino Diphenyl Methane (TGDDM) or Tetra-functional epoxy resin, Epoxy Novolac Resin, and Cycloaliphatic Epoxy Resin.

A curing agent is used to cure the Formula B. This curing agent can be amine, anhydride, phenol or thiol containing curing agents. The percentage of curing agent to the Formula B can be a loading range from 0 to 50% (w/w), preferably 10 to 40% (w/w) depending upon the composition of Formula B. The total weight or loading of curing agent in the resin formulation depends upon the expected reaction between the resin and the curing agent, which can be calculated from the presence of number of epoxide groups in the resin. It is expressed as epoxide equivalent weight. So the loading varies for different number of epoxide groups. Loading is a known stoichiometric ratio calculation, and is described in the following articles which are incorporated by reference herein in their entireties:

http://www.epoxychemicals.com/files/Download/Calculating+Equivalent+Weight+of+Epoxy+Mixtures[1].pdf and http://www.reichhold.com/brochures/coatings/WEB-EPOTUF-Brochure.pdf

In order to shorten the curing period, an initiator/accelerator can be used to initiate and expedite the reaction between the base resin and the curing agent. This initiators can be latent curatives such as methylene diamine (MDA), isophorone diamine, imidazoles, or cumene peroxide. The loading of initiator depends upon other combination and epoxide equivalent weight of the resin. The range of loading of the initiator can be from 0 to 20% (w/w), preferably less 10% (w/w).

The mixing of Formula B with the curing agent can be carried out at a temperature from 20° C. to 100° C., preferably from 30° C. to 80° C. A continuous stirring to the mixture aids to produce a homogeneous resin formula which is a one part epoxy resin containing curing agent. This mixture of the epoxy resin containing curing agent can be called as Formula C. Therefore, this mixed formula of epoxy resin containing curing agent (Formula C) can be cured at higher temperature by heating the mixed resin where the cure temperature varies from 50° C. to 200° C., preferably from 70° C. to 180° C., more preferably 90° C. to 160° C. for 0 minutes to 180 minutes, preferably 5 minutes to 120 minutes, more preferably less than 60 minutes. Note that if the curing agent is a phenolic hardener or phenolic based curing agent, and phenolic is inherently flame retardant, then phenolic hardener acts both as a curing agent and as an chemical to impart fire retardancy.

With the mixing of curing agent in the Formula B, the viscosity of the chemical mixture (Formula C) increases over time or with higher shear or with other factors. Sometimes it is possible to dilute the Formula C to reduce its viscosity by adding cycloaliphatic epoxy resin or glycidyl ether (e.g., methyl propyl ether) or any solvent in order to reduce the viscosity of Formula C, so that the mixed resin can be handled better during the application process and impregnation of the Formula C into the fabric used for prepreg production is improved. The viscosity value can vary depending upon the handle-ability of the equipment used for producing prepreg. In general, the viscosity should be as low as possible so that it will be easier to handle the resin during prepreg production, preferably to less than 2000 centipoise; and more preferably to below 1000 centipoise.

It is possible to improve the toughness properties and coupling properties of resin. The chemicals, i.e., Formula B or curing agent, can be mixed with a thermoplastic toughening agent (e.g., engineering thermoplastics), rubber toughening agent (e.g., core shell) or silicon containing toughening or coupling agent (e.g., poly dimethyl siloxane, methoxy silane or ethoxy silane) at a temperature from room temperature to 70° C. where the loading of the toughening agent is in between 0 to 30% (w/w), preferably 5 to 25% (w/w) with Formula B. Preferably the toughening agent is added to Formula B. It is also possible to add the toughening agent separately after completion of the preparation of Formula B or with the curing agent or with the Formula C. However mixing the toughening agent with Formula B during mixing process in formulation is believed to make the toughening process more effective.

Furthermore, the toughening agent can be modified with fire retardant additives before adding it to the epoxy resin. Also, there are other additives which can improve properties of epoxy resin, such as thermal conductivity. For example some chemicals have higher capability to absorb heat and transfer the heat, for example—aluminum, silver, boron. These additives come predominantly in powder form, although also in paste form. It is possible to encapsulate the toughening agent by a suitable mineral based additives such as aluminum oxide, aluminum nitride, boron nitride, etc. It is possible to impart further fire retarding properties to the epoxy resin Formula B by adding fire retardant materials further. In this case, the fire retardant can be added to chemical Formula B or curing agent or diluent to be added or any chemical added to the epoxy resin. The loading of the additional fire retardant can be a range from 0 to 30% (w/w), preferably less than 20% (w/w) to the Formula B or curing agent. Here, phosphorus or nitrogen or silicon or boron containing fire retardant or intumescent is more preferred to improve the fire properties in order to obtain synergistic effect of the fire retardants. For example more than one fire retardant can be added and by also adding an intumescent, a synergistic fire retardant effect is found. See, for example, the following article which is incorporated herein:

https://onlinelibrary.wiley.com/doi/full/10.1002/pc.24956.

It is possible to introduce further fire retardation properties to epoxy resin Formula By adding fire retardant materials further to the diluent which carries the fire retardants to the final formula of the epoxy resins. These fire retardants could be phosphorus or nitrogen or silicon or boron containing fire retardant or intumescent, or combination of two types of fire retardants or combination of three types of fire retardants.

The curing reaction speed can be improved with an addition of accelerator which will enable to reduce the curing dwell time. This accelerator could be imidazole based or urea based or boron trifluoride amine complex or dicyandiamide based or organic acid hydrazide based, or combination of these accelerators. Specific examples of accelerators include amine based accelerators—isophorone diamine, menthane diamine, 1,2-diaminocyclohexane, 1,3-diaminocyclohexane, 1,4-diaminocyclohexane, 1,3-di(aminomethyl)cyclohexane, 4,4′-methylene dicyclohexylamine, 4,4′-diaminodicyclohexylmethane, 3,3′-dimethyl-4,4′diaminodicyclohexyl-methane; and imidazole based accelerators—1 ethyl 2 methyl imidazole, 2 ethyl 4 methyl imidazole, imidazolides (N-acylimidazies), 2-phenylimidazoles; urea based accelerators—guanidines, cyanoguanidines, phenylguanidine, tert-butylguanidine, guanyl urea phosphate (acts as an accelerator and fire retardant)

Furthermore, the Formula C or any combination of mixing further chemicals to Formula B or C will be used for resin transfer molding process, resin infusion molding process, hand lay up or spray layup fabric impregnation process, prepreg manufacturing process or any process where final product is a composite or for the application in composite production.

The overall combination of the above chemicals is to produce epoxy resin system which is fire retardant can be used for any application to produce composites as final product, regardless of requirement of low flammability or no flammability. This resin can be used in the application of aerospace, automotive, transport, industrial, domestic, etc.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A composition formed of an epoxy resin incorporating a fire retardant.

2. The composition of claim 1 wherein the fire retardant is one or more of the following: aluminum trihydrate (ATH), magnesium hydroxide (MgOH), ammonium polyphosphate, melamine phosphate, organophosphorus, red phosphorus, intumescent, melamines, melamine cyanuratecyanides, polyhydro oligomeric silsesquioxane, zinc borate, decabromo diphenyl ether, tetrabromophenol, phosphonic acid, phosphate ester, phosphonate, phosphinate, Triphenyl phosphate, Tritolyl phosphate, tricresyl phosphate, triaryl phosphate, resorcinol bis(diphenyl phosphate), bisphenol A bis(diphenyl phosphate), polyphosphonate, phosphinic acid salts, red phosphorus; Ammonium phosphate, diammonium phosphate, triammonium phosphate, ammonium poly phosphate, melamine phosphate, melamine polyphaste, melamine pyrophosphate, Guanidine phosphate, 9, 10-dihydro-9-oxa-10-phosphaphenanthrene-10-oxide (DOPO),—polyhedral oligomeric silsesquioxane (POSS); zinc borate, sodium borate, ammonium borate, barium metaborate; aluminum trihydrate, magnesium hydroxide, mica, zeolite, bentonite, iron oxide; pentaerythritol based FRs and expandable graphites.

3. A mixture of the composition of claim 1 further with a curing agent.

4. A liquid mixture of an epoxide resin having incorporated therein a fire retardant, and a curing agent.

5. The composition of claim 4 wherein the resin is cured and the resultant material used as a composite material for aircraft construction.

6. A base resin made according to the following process 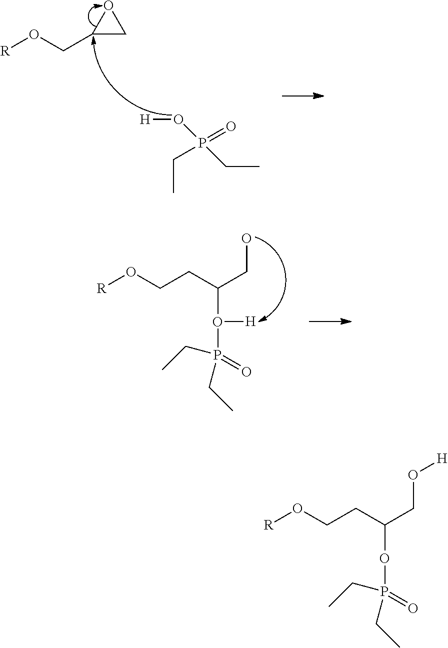
wherein R is chosen from one or more of the: DiGlycidyl Ether of Bisphenol A (DGEBA), DiGlycidyl Ether of Bisphenol F (DGEBF), Bisphenol S epoxy resin, TriGlycidyl Para Amino Phenol (TGPAP) or Tri-functional epoxy resin, TetraGlycidyl Diamino Diphenyl Methane (TGDDM) or Tetra-functional epoxy resin, Epoxy Novolac Resin, Cycloaliphatic Epoxy Resin, and mixtures thereof, and the HPO2 group is a flame retardant.

7. A process for making a composite comprising the following steps:
(a) making an epoxide resin having a fire retardant incorporated therein;
(b) adding a curing agent; and
(c) curing the mixture of the resin and curing agent.

8. The process according to claim 7 wherein the curing agent is selected from the group consisting of amine, anhydride, phenol or thiol containing curing agents or mixtures thereof.

9. A process for making a composite comprising mixing one or more multi-functional epoxy resins with a difunctional epoxy resin and a flame retardant at a temperature range between 50° C. to 200° C. in a controlled environment.

10. The process of claim 9 wherein the multi-functional epoxy resins are chosen from the group consisting of trifunctional, tetra functional, epoxy phenol novolacs or epoxy cresol novolacs or mixtures thereof, and the difunctional epoxy resin is chosen from the group of Bisphenol A or Bisphenol F or Bisphenol S containing epoxy resins and mixtures thereof, and a flame retardant, and where the mixing temperature ranges between 90° C. to 160° C.

11. The process according to claim 10, wherein the percentage of multifunctional epoxy resin mixed in the formula is between 10 to 90% (w/w), and percentage of difunctional epoxy resin mixed in the formula is between 10 to 90% (w/w), and loading of fire retardant mixed in the formula is between 0 to 40% (w/w).

12. The process according to claim 11 wherein after mixing, the mixture is cooled down to a temperature between 20° C. to 90° C., and once cooled, a diluent epoxy resin is added to the mixture.

14. The process according to claim 13 wherein the diluents are selected from the group consisting of monofunctional epoxy resins and aliphatic epoxy resins comprising C8-C10 aliphatic glycidyl ether, C12-C14 glycidyl ether, ethyl hexyl glycidyl ether, ortho-cresyl glycidyl ether, 1,4-butanediol diglycidyl ether, trimethylon propane triglycidyl ether, Neopentyl glycol diglycidyl ether, and mixtures thereof.

15. A fire retardant base resin comprising: 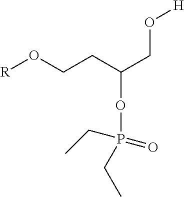
wherein R is an epoxy resin with at least one epoxide group, and the HPO2 group is a flame retardant with a phosphinic acid group.
